(19) United States
(12) Patent Application Publication
(10) Pub. No.: US 2013/0152836 A1
(43) Pub. Date: Jun. 20, 2013

(54) Seed Tape Planter

(71) Applicants: Kevin L. Deppermann, St. Charles, MO (US); Brian Jacob Forinash, St. Louis, MO (US); Travis Frey, Brentwood, MO (US); Marcus McNabnay, Edwardsville, IL (US)

(72) Inventors: Kevin L. Deppermann, St. Charles, MO (US); Brian Jacob Forinash, St. Louis, MO (US); Travis Frey, Brentwood, MO (US); Marcus McNabnay, Edwardsville, IL (US)

(73) Assignee: MONSANTO TECHNOLOGY LLC, St. Louis, MO (US)

(21) Appl. No.: 13/637,320

(22) PCT Filed: Mar. 16, 2011
(86) PCT No.: PCT/US11/28630

§ 371 Date: Jan. 18, 2013

Related U.S. Application Data
(60) Provisional application No. 61/317,906, filed on Mar. 26, 2010.

(51) Int. Cl. A01C 7/04

(52) U.S. Cl. CPC A01C 7/048
USPC 111/199

(57) ABSTRACT

A system and method are disclosed for the planting of a seed tape. The system includes a frame configured for coupling to a tractor, a furrow opening device attached to the frame, and a furrow closing device attached to the frame. In one embodiment, a seed tape guide assembly is attached to the frame and has a tamping arm for guiding the seed tape. In another embodiment, a seed tape wheel is attached to the frame by a mounting arm and positioned within at least a portion of the furrow opening device. The mounting arm is biased by a biasing member and the seed tape wheel is forcibly pressed by the mounting arm into contact with the furrow.

### FIELD

This disclosure generally relates to agricultural planters and, more specifically, to systems and methods for planting a seed tape.

### BACKGROUND

Seeds may be placed on or in a substrate to facilitate the accurate placement of seeds, such as in research or trial planting applications. The substrate may be a paper-like substance and is commonly referred to as “seed tape” or simply “tape”. Typically, seeds are uniformly spaced-apart on the tape, thus facilitating uniform spacing of plants grown from the seeds. The uniform spacing of the seeds may also reduce the need to thin the plants. The seeds can be attached to the tape by any suitable method, such as adhesive bonding or placement between two layers of the tape. Other substances, such as herbicide or fertilizer, may be disposed on the tape to aid in the growth and development of the seed. The seed tape may be wound into a roll or coil prior to planting.

In operation, the seed tape is planted in the soil by a planter pulled behind a prime mover (e.g., a tractor). The seed tape is typically placed into an open furrow formed in the soil by the planter. The furrow is then covered or closed by the planter. At some point after planting of the seed tape, the tape may biodegrade or dissolve so that it does not inhibit the germination of the seeds.

Maintaining the position of the seed tape within the furrow prior to the closing of the furrow helps ensure that the spacing of the seeds is maintained. If the position of the tape is not maintained, the tape may shift location in the furrow. Previous systems have sought to maintain the position of the seed tape within the open furrow prior to its closing though a variety of methods. In some planters, the seed tape is cut into individual sections and inserted into the furrow, while in others the seed tape is directed through a tube into the furrow. Other planters have used a rotating wheel to hold the seed tape in place in the furrow. These previous systems have generally yielded unsatisfactory results.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect is a system for planting a seed tape comprising a frame configured for coupling to a tractor, a furrow opening device attached to the frame,

a seed tape guide assembly attached to the frame and having a tamping arm for guiding the seed tape, and a furrow closing device attached to the frame.

Another aspect is a seed tape guide assembly for guiding a seed tape into a furrow formed by a seed tape planter. The seed tape guide assembly comprises a guide frame configured for attachment to a frame of the seed tape planter. A first guide plate is attached to the guide frame and is configured for routing the seed tape from a payout roll into the guide frame. A tamping arm has a first end and a second end and the first end extends downwards from the guide frame toward and contacting the furrow formed by the seed tape planter. The second end is attached to the guide frame. The tamping arm has a width approximate to a width of the seed tape.

Another aspect is a system for planting a seed tape. The system comprises a frame configured for coupling to a tractor, a furrow opening device attached to the frame and being operable to form a furrow in the soil upon forward motion of the frame, and a seed tape wheel attached to the frame by a mounting arm and positioned within at least a portion of the furrow opening device. The mounting arm is biased by a biasing member and the seed tape wheel is forcibly pressed by the mounting arm into contact with the furrow. The seed tape member is configured for contact with the seed tape. A furrow closing device is attached to the frame and is operable to close the furrow formed by the furrow opening device.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

The embodiments described herein may be better understood by referring to the following description in conjunction with the accompanying drawings.

FIG. 1 is a perspective view of an exemplary seed tape planter.

FIG. 2 is a side view of the exemplary seed tape planter of FIG. 1.

FIG. 3 is a top plan view of a portion of an exemplary seed tape.

FIG. 4 is a side view of an exemplary seed tape guide assembly.

FIG. 5 is an enlarged view of a portion of FIG. 4.

FIG. 6 is a cross-section of FIG. 5 taken along the line 6-6.

FIG. 7 is a perspective view of an exemplary seed tape payout assembly.

FIG. 8 is a perspective view of another embodiment of a seed tape planter.

FIG. 9 is a side view of the seed tape planter of FIG. 8

FIG. 10 is an end view of the seed planter of FIG. 8.

### DETAILED DESCRIPTION

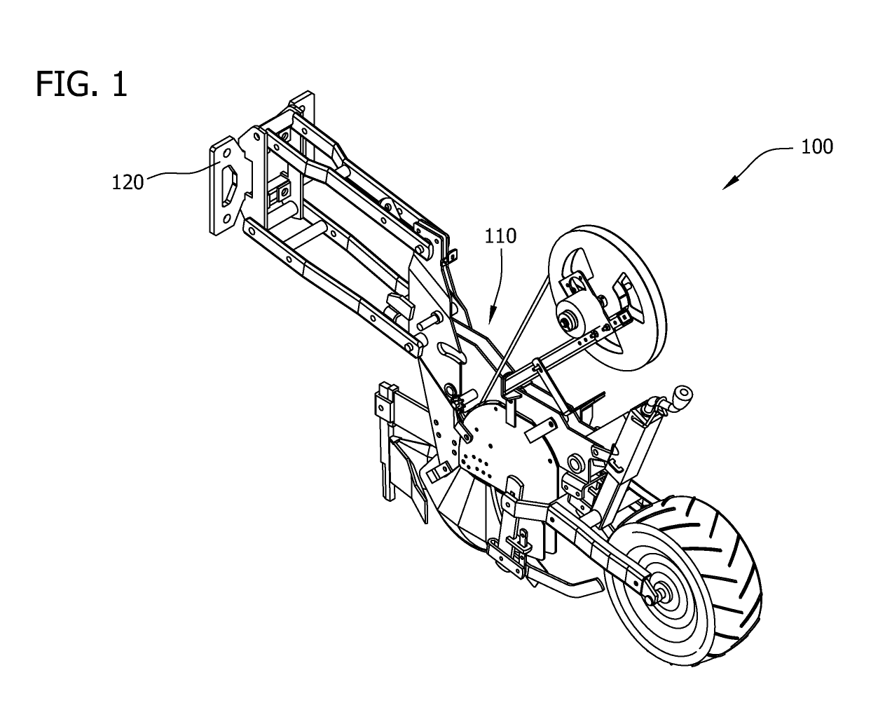

Referring to FIG. 1, an embodiment of a planter 100 for planting a substrate having seeds is shown. Other types and embodiments of planters for planting such substrates are contemplated within the scope of this disclosure.

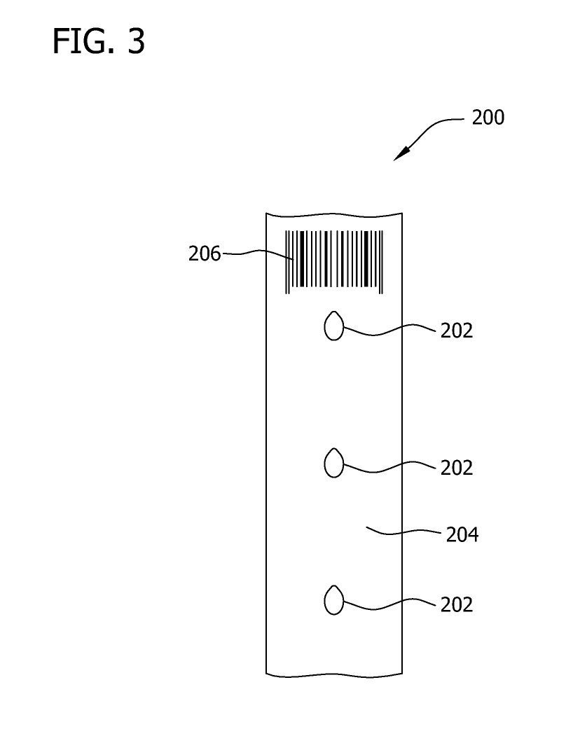

The substrate or “seed assembly” is referred to hereinafter as a seed tape or tape, a portion of which is indicated generally at 200 and best seen in FIG. 3. A substrate 204 of the seed tape includes holes therein. Each hole is sized to receive a seed 202, and each hole is uniformly spaced from the next hole so that the seeds are evenly, uniformly spaced apart. In other embodiments, each seed 202 is affixed to the substrate 204 by adhesive. Alternatively, the seeds 202 are disposed on the substrate 204, e.g. placed in the approximate center of the seed tape 200, and the seed tape is folded over (lengthwise) to encapsulate the seeds.

In some embodiments, the position of each of the individual seeds 202 on the substrate 204 may be randomized. An identifying indicia 206 may also be placed on the substrate 204 of the seed tape 200. The indicia 206 provides a mechanism to track and identify a specific seed tape from production to planting. The identifying indicia 206 may be machine-readable (e.g., a barcode) in one embodiment. In other embodiments, the identifying indicia 206 may include other identification elements (e.g., a radio frequency identification tag). The identifying indicia 206 may also include information identifying each one of the seeds 202 in the seed tape 200 and their position on the substrate 204.

In certain embodiments, the systems and methods described herein are useful in breeding programs wherein seeds are selected for planting based on known or desired characteristics. For example, such breeding programs may include seeds which have been sampled and selected by automated tissue sampling and analysis as described in U.S. Pat. Nos. 7,502,113; 7,591,101 and 7,611,842, all of which are incorporated herein by reference.

The use of the identifying indicia 206 provides for the tracking of individual seeds 202 during their growth, thus eliminating the need for costly and time consuming tissue sampling of plants grown from the seeds. The preservation of the identity and location of the individual seeds 202 in the seed tape 200 is also useful in applications where genetic information has been collected for each individual seed, such as in the breeding programs above. The genetically identified seeds are then easily tracked during their life cycle, as their identity and location on the substrate 204 of the seed tape 200 are known. Moreover, only specific types of genetically identified seeds may be placed within a randomized trial by placement on the substrate 204. These specific types of genetically identified seeds may then be tracked during their life cycle because of their known identity and location on the substrate 204.

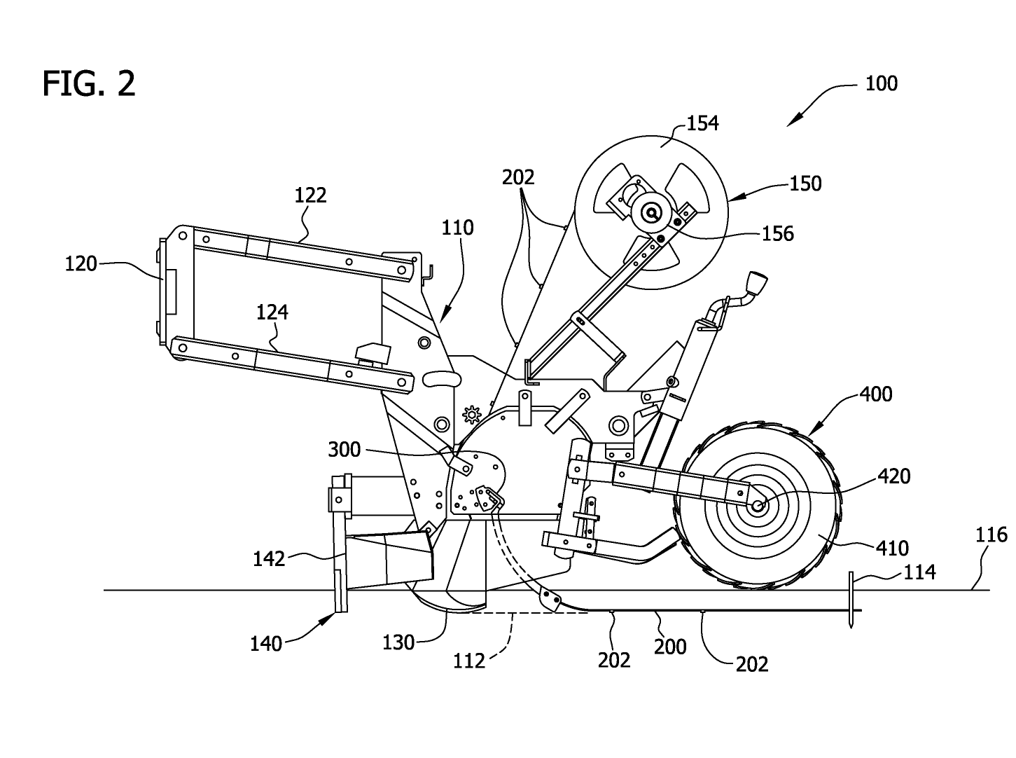

With reference now to FIGS. 2 and 3, the planter 100 has a frame 110 onto which the various components of the planter are attached. The frame 110 may be formed from any suitable material, such as steel. The planter 100 is configured to be pulled behind a tractor (i.e., a prime mover). An adapter plate 120 (broadly, a “coupling device”) is attached by a pair of connecting members 122, 124 to one end of the frame 110. The adapter plate 120 is configured to couple the planter 100 to a toolbar or other implement that is in turn coupled to the tractor. In embodiments where the adapter plate 120 couples the planter 100 to a toolbar, the adapter plate 120 may be coupled to a carriage within the planter.

A furrow opening device 130 is disposed on the frame 110 and is configured to form an opening (i.e., a furrow 112) in an area of soil 114 suitably sized for placing the seed tape 200 therein. In the exemplary embodiment, the furrow opening device 130 comprises a blade-shaped member forced into the soil 114 by the planter 100 that forms a shallow trench as the planter is pulled forward. The furrow opening device 130 may be formed from any suitable material (e.g., steel). The depth and width of the trench may be changed, for example by adjusting the furrow opening device 130 or replacing the device with a differently configured furrow opening device. In another embodiment, the furrow opening device 130 comprises a rotatable first disc and a rotatable second disc that together form a furrow in the soil as the planter 100 is pulled forward.

A clod buster 140 is positioned nearer the adapter plate 120 than the furrow opening device 130 and breaks apart clods or large portions of dirt prior to their contacting the furrow opening device 130. The clod buster 140 may be formed from steel or any other suitable material. In the exemplary embodiment, the clod buster 140 includes a clod buster member 142 that extends downward from the frame 110 by a distance less than that of the furrow opening device 130.

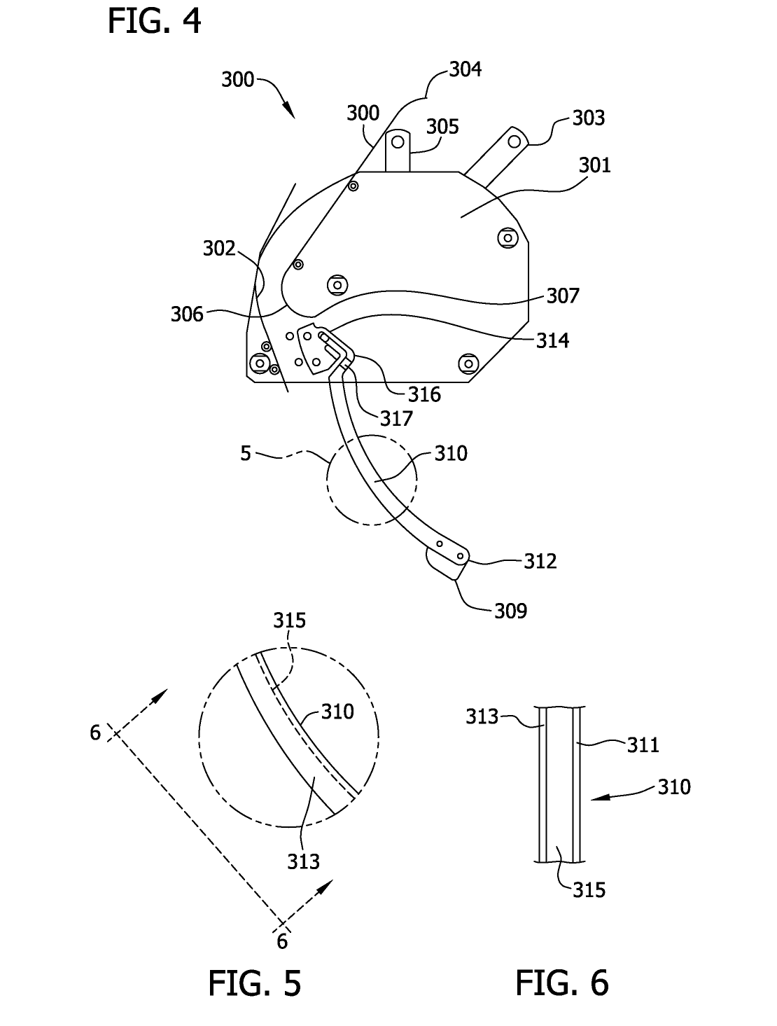

Turning now to FIGS. 3 and 4, a seed tape guide assembly 300 (referred to herein as a “tape guide”) of this embodiment is adapted for guiding and positioning the seed tape 200 into a furrow created in the soil by the furrow opening device 130. The seed tape 200 is omitted from FIG. 4 for clarity. The tape guide 300 includes a guide frame 301 to which the other components of the tape guide are mounted. The guide frame 301 is suitably attached to the frame 110 of the planter 100 at a first connection 303 and a second connection 305, as by any suitable mechanism (e.g., mechanical fasteners or welding). Alternatively, the guide frame 301 and frame 110 could be formed as one piece.

Once the seed tape 200 has entered the tape guide 300, it is guided between a first guide plate 302 and second guide plate 307. The guide plates 302, 307 are attached to the guide frame 301 and guide the seed tape first into contact with a first end of the first guide plate 302 and then into contact with a curved section 306 of the first guide plate.

A tamping arm 310 having a first end 312 and a second end 314 is disposed vertically below the guide plates 302, 307. A shoe member 309 is attached to the tamping arm 310 near the second end 314 and keeps the sidewalls of the furrow from collapsing before the seed tape 200 is placed therein. The shoe member 309 also acts as a guide to keep the seed tape 200 positioned as it travels into the furrow. The shoe member 309 may also have a web and a pair of horizontally spaced-apart walls the height of which is sized such that the seed tape 200 is contained therein during operation of the planter.

The second end 314 of the tamping arm 310 may be attached to the guide frame 301 by any suitable connection mechanism (e.g., mechanical fasteners or welding). The tamping arm 310 is formed from any suitable material that is sufficiently resilient and capable of returning to its original shape after deformation (e.g., a spring steel or composite material). In some embodiments, the tamping arm 310 is made from polypropylene or ultra high weight polyethylene (UMHW). The tamping arm 310 has a curved section 316 near its second end 314 to permit flexure of the tamping arm. The tamping arm 310 may be coupled to the guide frame 301 with suitable fasteners. Moreover, a screw (not shown) may be placed through an opening 317 in the tamping arm 310 to limit the flexure of the arm.

As shown in FIGS. 5 and 6, the tamping arm 310 of this embodiment is channel-shaped and has a web 315 and a pair of horizontally spaced-apart walls 311, 313. The web 315 is disposed between the walls 311, 313. The width of the web 315 is slightly wider than the seed tape 200. The height of the walls 311, 313 is sized such that the seed tape 200 is contained therein during operation of the planter 100. In other embodiments, the tamping arm 310 does not have a pair of horizontally spaced-apart walls 311, 313 and instead has a flat surface.

A furrow closing device 400 is attached to the frame 110 and positioned to the right (i.e., aft) of the furrow opening device 130 in FIG. 2. The furrow closing device 400 is a rotatable wheel 410 in this embodiment, but other devices are contemplated. The wheel 410 is mounted at a center point 420 to the frame 110. As the planter 100 is pulled behind the tractor, the wheel 410 rotates and fills in the furrow created by the furrow opening device 130. In some embodiments, the wheel 410 may be a rubber tire mounted on a rim. In other embodiments, a pair of scrapers (not shown) may first scrape soil into the furrow the wheel 410 then compacts the soil.

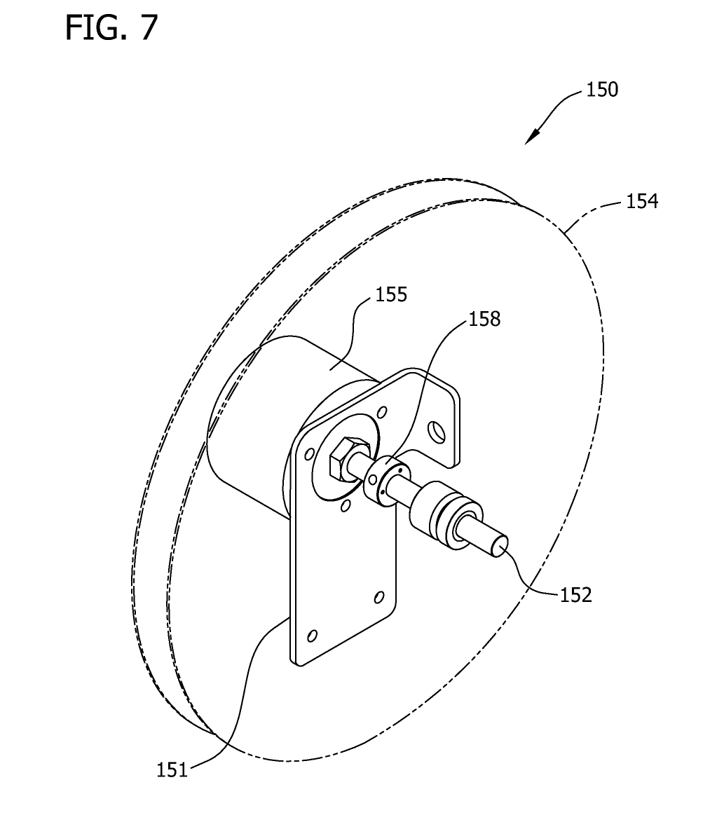

With reference now to FIG. 7, a tape payout mechanism 150 is attached to an upper portion of the frame 110 by a payout frame 151. The tape payout mechanism 150 is attached to the frame 110 by any suitable connection mechanism (e.g., welding or mechanical fasteners). The tape payout mechanism 150 includes a payout shaft 152 onto which a seed tape roll 154 (FIG. 2) is releasably mounted. The seed tape roll 154 contains at least a portion of the seed tape 200 wound around a hub 156. The hub 156 is in turn coupled to the payout shaft 152 by a suitable fastening mechanism. In the embodiment of FIG. 5, an outboard collar 156 and an inboard collar 158 couple the seed tape roll 154 to the payout shaft 152.

The payout shaft 152 is mounted to a brake 155 that is in turn mounted to the payout frame 151. The brake 155 increases the amount of torque needed to rotate the payout shaft 152. The brake 155 may be adjusted to increase or decrease the amount of torque necessary to rotate the payout shaft 152. In some embodiments, the torque may be adjusted based on the type of material that is used to form the substrate 204 of the seed tape 200. Moreover, by increasing the amount of torque required to rotate the payout shaft 152 (and in turn the tape roll 154), the tension in seed tape 200 may be increased and controlled as the seed tape 200 is planted.

In the embodiment of FIG. 5, the brake 155 is a hysteresis brake with a permanent magnet in which the torque required to rotate the payout shaft 152 is adjustable. In other embodiments, a current-controlled brake is used and the torque applied by the brake is altered by varying the amount of electrical current applied to the brake by a control system (not shown). In other embodiments, the brake 155 is a spring-loaded friction brake. In still other embodiments, any suitable braking device that increases the amount of torque necessary to rotate the shaft may be used in the brake 155.

In an example method of operation, before commencement of movement of the planter 100 and planting of the seed tape 200, the identifying indicia on the substrate 204 of the seed tape 200 may be read. In embodiments using machine-readable identifying indicia 206 (e.g., a barcode or RFID tag), a scanning system is used to read the indicia. The identity of the seed tape 200 is confirmed, e.g., by comparing the indicia against a database, to ensure that the correct seed tape is being planted. After confirmation that the seed tape 200 is the correct tape, a first end of the seed tape is threaded through the planter 100. The threading of seed tape 200 through the planter 100 may be performed by an operator of the planter. The seed tape 200 is first paid out from the tape roll 154. The seed tape 200 is then threaded through the guide assembly 300, first passing through the guide plates 304, 307. The seed tape 200 then comes into contact with the tamping arm 310 at or near the second end 314 the tamping arm. The walls 311, 313 of the tamping arm 310 restrict the seed tape 200 from lateral movement within the tamping arm 310. The seed tape 200 then exits the tamping arm at or near the first end 312 thereof. The first end of the seed tape 200 is then attached to the soil 116 in the bottom of the furrow 112 formed by the furrow opening device 130. In some embodiments, the first end of the seed tape 200 is attached to the soil by a stake 116 (FIG. 2).

Planting then begins by moving the planter 100 forward. As described above, a tractor may be used to pull the planter 100 forward. Alternatively, the planter 100 may be a self-propelled system. As the planter 100 is pulled forward, the clod buster 140 breaks up any clogs of soil before they come into contact with the furrow opening device 130. The furrow device 130 forms an appropriately sized furrow in the soil for the seed tape 200.

As the planter 100 moves forward, the seed tape 200 is paid off of the tape roll 154. The brake 155 increases the amount of torque required to rotate the tape roll 154, and thus ensures that a proper amount of tension is maintained in the seed tape 200 as it is paid out. The seed tape 200 continues to pass between the guide plates 304, 307 and then into contact with the tamping arm 310. The walls 311, 313 prevent the seed tape 200 from moving laterally out of the channel.

As the seed tape 200 passes through the channel, the tape comes into contact with the first end 312 of the tamping arm 310. The first end 312 presses the seed tape 200 against the furrow formed by the furrow opening device 130. The first end 312 of the tamping arm 310 thus ensures that the seed tape 200 remains in the furrow until the furrow is closed by the furrow closing device 400. Moreover, because of the tension maintained in the seed tape 200 by the brake 155 in the tape payout mechanism 150, the seed tape does not bunch up or otherwise double over on itself before the furrow is closed by the furrow closing device 400. Accordingly, the precise spacing of the seeds 202 on the substrate 204 of the seed tape 200 is maintained as the tape is planted in the furrow.

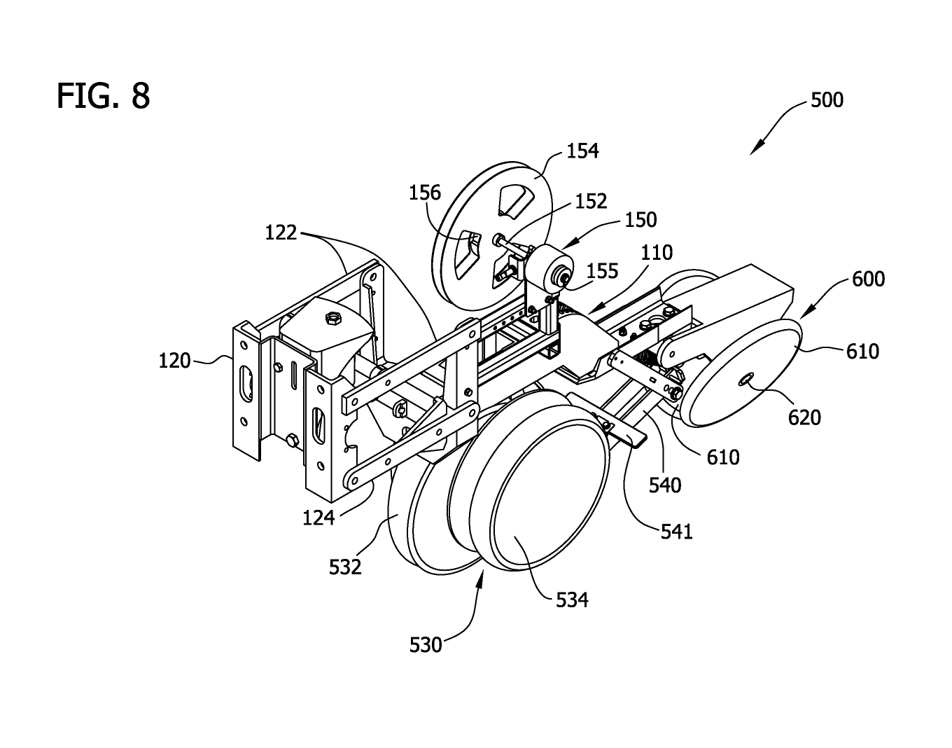

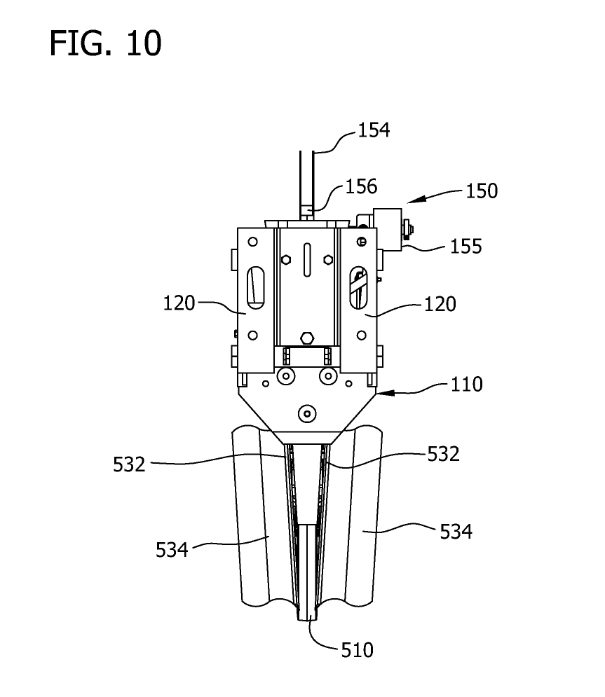

FIGS. 8-10 show a second embodiment of the planter 100 similar to the embodiment described above in FIGS. 1-7 and like reference numerals are used to refer elements common between the embodiments. However, the second embodiment of the planter 100 uses different devices for opening the furrow, guiding and positioning the seed tape 200 within the opened furrow, and closing the furrow. Moreover, a dampener 121 is used to dampen the motion of connecting members 122, 124 as the planter 110 is pulled forward by the tractor. Accordingly, as the planter 110 encounters irregularities in the soil the upward and downward movement of the connecting members 122, 124 the dampener 121 dampens the movement of the connecting members and the planter 110.

A furrow opener 530 is attached to the frame 110 and is configured to form a furrow in the soil suitably sized for placing the seed tape 200 therein. The furrow opener 530 comprises a pair of inner discs 532 that are forced into the soil by the planter 100 to form a shallow trench as the planter is pulled forward. A pair of gauge wheels 534 are positioned adjacent the inner discs 532 and control the depth of the furrow relative to the surface by limiting the travel of their respective mounting arms (not shown) with a selector linkage (not shown). The inner discs 532 and gauge wheels 534 may be constructed from any suitable material (e.g., steel or alloys thereof).

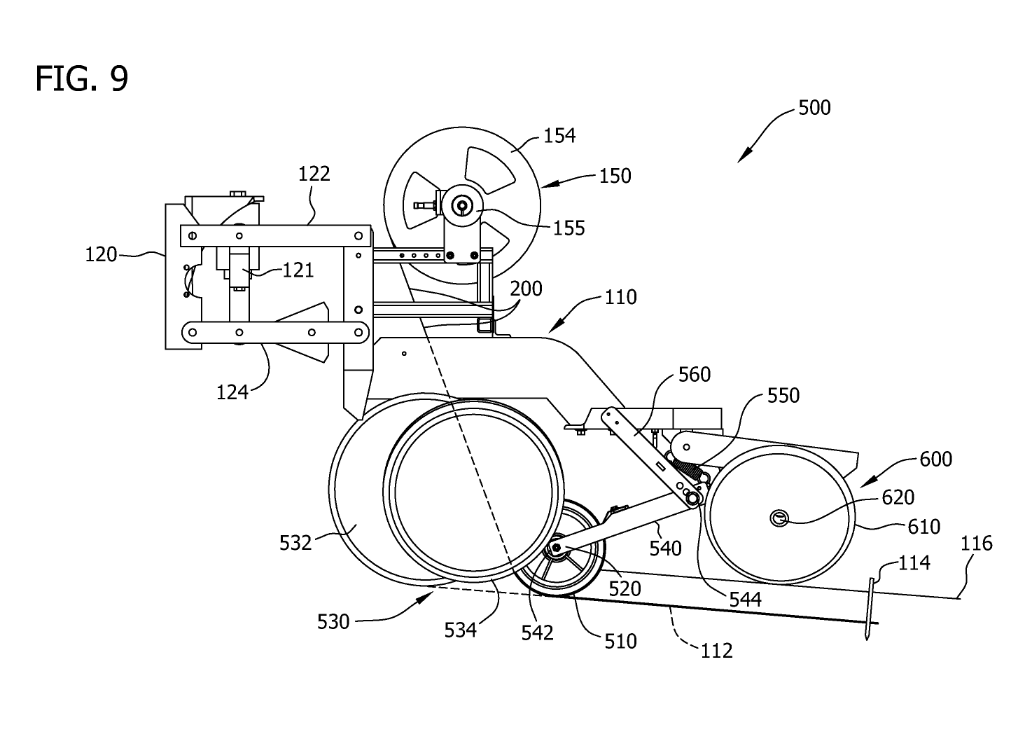

A seed tape wheel 510 (shown in FIG. 9) is used to guide and position the seed tape 200 within the furrow created by the furrow opener 530. The seed tape wheel 510 may be constructed from any suitable material (e.g., steel) and in some embodiments has a rubber or rubber-like outer coating. A mounting arm 540 couples the seed tape wheel 510 to the frame 110 of the planter 100. The seed tape wheel 510 rotates about a center point 542 that is coupled to a first end 520 of the mounting arm 540. A wheel scraper 541 is attached to the mounting arm 540 to scrape dirt or debris from the surface of the seed tape wheel 510 as it rotates. The mounting arm 540 is coupled to a mounting link 560 at a second end 544 such that the mounting arm may rotate about the point where the second end is coupled to the mounting link. The mounting link 560 is then in turn attached to the frame 110. As shown in FIG. 9, a spring 550 (broadly, a “biasing member”) is attached to the second end 544 of the mounting arm 540. The force exerted on the mounting arm 540 by the spring 550 results in the second end 520 of the mounting arm being biased downward towards the soil. The downward biasing of the second end 520 in turn presses the seed tape wheel 510 against the bottom of the furrow created by the furrow opener 530. In other embodiments, the spring 550 may be substituted with any other suitable device that is capable of exerting a force on the second end 544 of the mounting arm 540.

As shown in FIG. 9, the mounting arm 540 positions the seed tape wheel 510 between the gauge wheels 534. By positioning the seed tape wheel 510 in such a manner, the seed tape wheel is able to guide and position the seed tape 200 within the furrow before the furrow is closed.

A furrow closer 600 is disposed to the right or rearward of the seed tape wheel 510 and furrow opener 530 as viewed in FIG. 9 so that the closer contacts the soil after the opener and the wheel. The furrow closer 600 is suitably attached to the frame 110 and includes a pair of closing discs 610. The closing discs 410 are rotatably mounted at a center point 620 to the frame 110. As the planter 110 is pulled behind the tractor, the closing discs 610 rotate and fill in the furrow created by the furrow opener 530.

In operation, before the commencement of movement of the planter 100 and planting of the seed tape 200, the first end of the seed tape 200 is threaded through the planter. The seed tape 200 is first paid out from the tape roll 154 and pulled downward into contact with the seed tape wheel 510. The first end of the seed tape 200 is pulled past the seed tape wheel 510 and attached to the soil in the bottom of a furrow formed by the furrow opener 530. The first end of the seed tape 200 is attached to the soil by a stake in some embodiments.

The operation of the planter 100 then begins with the forward movement of the planter. As the planter 100 is pulled forward, the furrow opener 530 forms an appropriately sized furrow in the soil for the seed tape 200. The inner discs 530 form the furrow as they rotate and are forced into the soil by the forward movement of the planter 100. The pair of gauge wheels 534 ensure that the sidewalls of the furrow do not collapse before the seed tape 200 is placed therein.

The seed tape 200 travels from the tape roll 154 through the frame 110 and into contact with the seed tape wheel 510. The path of the seed tape 200 is shown in FIG. 9. The seed tape wheel 510 guides and positions the seed tape within the furrow created by the furrow opener 530. Moreover, the spring 550 attached the second end 544 of the mounting arm 540 presses the seed tape wheel 510 and the seed tape 200 in contact therewith into the bottom of the furrow. As the seed tape 200 passes between the seed tape wheel 510 and the bottom of the furrow, the seed tape is pressed into the soil at the bottom of the furrow. The force exerted by the seed tape wheel 510 onto the seed tape 200 ensures that the seed tape 200 remains in the furrow until the furrow is closed by the furrow closer 600. Moreover, because of the tension maintained in the seed tape 200 by the brake 155 in the tape payout mechanism 150, the seed tape does not bunch up or otherwise double over on itself before the furrow is closed by the furrow closer 600. Accordingly, the spacing of the seeds 202 on the substrate 204 of the seed tape 200 is maintained. After the seed tape 200 has been pressed into the furrow by the seed tape wheel 510, the furrow is then closed by the movement of closing discs 610 of the furrow closer 600.

This written description uses examples to disclose the invention, including the best mode, and also to enable any person skilled in the art to practice the invention, including making and using any devices or systems and performing any related methods. The patentable scope of the invention may include other examples that occur to those skilled in the art. Such other examples are intended to be within the scope of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of the present invention or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

What is claimed is:

1. A system for planting a seed tape, the system comprising:
a frame configured for coupling to a tractor;
a furrow opening device attached to the frame;
a seed tape guide assembly attached to the frame and having a tamping arm for guiding the seed tape; and
a furrow closing device attached to the frame.

2. The system of claim 1 wherein the furrow opening device is blade-shaped.

3. The system of claim 1 wherein the tamping arm extends down toward a furrow from the seed tape guide assembly.

4. The system of claim 3 wherein the tamping arm has a first end and a second end, the first end attached to the seed tape guide assembly and the second end configured to contact a bottom portion of the furrow during operation of the planter.

5. The system of claim 1 wherein the tamping arm comprises a shoe member disposed adjacent the second end of the tamping arm, the shoe member having opposed walls and a web, each of the walls disposed on opposite edges of the web.

6. The system of claim 1 further comprising a clod buster attached to the frame.

7. The system of claim 6 further comprising a coupling device for coupling the frame to the tractor.

8. The system of claim 7 wherein the clod buster is positioned between the coupling device and the furrow opening device.

9. A seed tape guide assembly for guiding a seed tape into a furrow formed by a seed tape planter, the seed tape guide assembly comprising:
a guide frame configured for attachment to a frame of a seed tape planter;
a first guide plate attached to the guide frame and configured for routing the seed tape from a payout roll into the guide frame;
a tamping arm having a first end and a second end, the first end extending downwards from the guide frame toward and contacting the furrow formed by the seed tape planter, the second end attached to the guide frame, the tamping arm having a width approximate to a width of the seed tape.

10. The seed tape guide assembly of claim 9 wherein the tamping arm comprises a pair of opposed walls and a web member, each of the walls disposed on opposite edges of the web member.

11. The seed tape guide assembly of claim 10 wherein tamping arm is configured such that the seed tape passes between the channel member at the first end of the tamping arm and the furrow as the seed tape planter is moved forward by a tractor.

12. The seed tape guide assembly of claim 9 further comprising a second guide plate attached to the guide frame and configured for cooperatively routing the seed tape from the payout roll into the guide frame with the first guide plate.

13. A system for planting a seed tape, the system comprising:
a frame configured for coupling to a tractor;
a furrow opening device attached to the frame and being operable to form a furrow in the soil upon forward motion of the frame;
a seed tape wheel attached to the frame by a mounting arm and positioned within at least a portion of the furrow opening device, the mounting arm biased by a biasing member, the seed tape wheel forcibly pressed by the mounting arm into contact with the furrow, the seed tape wheel configured for contact with the seed tape; and
a furrow closing device attached to the frame and operable to close the furrow formed by the furrow opening device.

14. The system of claim 13 wherein the furrow opening device includes a pair of rotatable inner discs.

15. The system of claim 14 wherein the furrow opening devices includes a pair of rotatable gauge wheels disposed outward from the inner discs, the gauge wheels configured to control the depth of the furrow formed by the inner discs.

16. The system of claim 13 wherein the mounting arm has a first end a second end, the first end attached to the seed tape wheel and the second end attached to the biasing member.

17. The system of claim 16 wherein the biasing member is a spring.

18. The system of claim 13 further comprising a wheel scraper attached to the frame and disposed adjacent the seed tape wheel, the wheel scraper configured to contact the seed tape wheel and scrape debris therefrom.

19. The system of claim 13 further comprising an identifying indicia disposed on the seed tape, the identifying indicia containing information describing at least one of the seeds in the seed tape.

20. The system of claim 19 wherein the identifying indicia is readable by a machine.

21. The system of claim 20 wherein the identifying indicia is a barcode.

22. The system of claim 20 wherein the identifying indicia is a radio frequency identification tag.
